(19) United States
(12) Patent Application Publication
(10) Pub. No.: US 2015/0037617 A1
(43) Pub. Date: Feb. 5, 2015

(54) SELECTIVELY CONDUCTING BATTERY CASING

(71) Applicant: OZCA Engineering Solutions Ltd., Maccabim-Reut (IL)

(72) Inventor: Oz CABIRI, Maccabim-Reut (IL)

(73) Assignee: OZCA Engineering Solutions Ltd., Maccabim-Reut (IL)

(21) Appl. No.: 13/958,774

(22) Filed: Aug. 5, 2013

(51) Int. Cl. H01M 2/02; H02J 7/00

(52) U.S. Cl. CPC H01M 2/0285; H02J 7/0052
USPC 429/7; 429/179; 429/151; 429/90; 29/623.1

(57) ABSTRACT

An electrochemical cell casing may be made from a non-conducting material. A conducting area may be formed on the casing. For example the conductive area may include a charge collector and/or a link and/or a terminal. The conducting area may be formed for example by coatings and/or deposits and/or molded interconnect device technology and/or multicomponent molding. An electrochemical cell may be modular. The cell may have interlocking features for stacking into a compound battery. An electrochemical cell may have an arbitrary shape, for instance prismatic. The cell may be flexible. The cell may fit into a standard battery receptacle.

### FIELD AND BACKGROUND OF THE INVENTION

The present invention, in some embodiments thereof, relates to a multi-component battery casing and, more particularly, but not exclusively, to a plastic battery casing having a novel geometry for a current collector, a current link and/or a terminal.

U.S. Pat. No. 8,318,340 to Stimits discloses “Electrochemical cells including a casing or cup for direct electrical terminal with a negative electrode or counter electrode and serving as the current collector for the electrode. The casing includes a substrate having a plated coating of an alloy including copper, tin and zinc, the coating having a composition gradient between the substrate and the external surface of the coating wherein the copper content is greater adjacent the substrate than at the external surface of the coating and the tin content is greater at the external surface of the coating than adjacent the substrate. Methods for forming a coated casing and an electrochemical cell including a coated casing are disclosed, preferably including providing an electrode casing with a coating utilizing variable current density plating that reduces discoloration of a surface exposed to the ambient atmosphere.”

### SUMMARY OF THE INVENTION

According to an aspect of some embodiments of the present invention there is provided an electrochemical cell, including: a housing including; one or more casing components; the housing enclosing a chamber, the chamber containing a first electrode, each of the casing components having an inside surface facing the chamber and an outside surface facing away from the chamber; a first of the casing components made of an electrically insulating material, and one or more electrically conducting areas selected from the group consisting of a current collector formed on the inside surface of the first casing component and contacting the first electrode, a first link including an interior portion formed on the inside surface of the first casing component and an exterior portion formed on the outside surface of the first casing component, and an electrical connection between the interior portion and the exterior portion, and a terminal formed on the outside surface of the first casing components, the terminal connectable to a power drain.

According to some embodiments of the invention, the electrochemical cell further includes a transport medium disposed between the first electrode and a second electrode,

According to some embodiments of the invention the electrochemical cell further includes a second electrode in electrical connection with a second link, the second link including a second interior portion formed on the inside surface of the first casing component and a second exterior portion formed on the outside surface of the first casing component and an electrical connection between the interior portion and the exterior portion and wherein the first link and the second link have a geometry avoiding shorting.

According to some embodiments of the invention the electrochemical cell further includes a second of the casing components made of an electrically insulating material; and a second electrode in electrical connection with a second link, the second link including a second interior portion formed on the inside surface of the second casing component and a second exterior portion formed on the outside surface of the second casing component and an electrical connection between the interior portion and the exterior portion and wherein the first link and the second link have a geometry avoiding shorting.

According to some embodiments of the invention, the casing has mechanically interlocking features.

According to some embodiments of the invention, the terminal is configured for forming a series connection upon the stacking in a first orientation.

According to some embodiments of the invention, the terminal is configured for forming a parallel connection upon the stacking in a second orientation.

According to some embodiments of the invention the electrochemical cell further includes an interconnector for electrically connecting two stacks of the electrochemical cells into a single electro motive unit.

According to some embodiments of the invention the electrochemical cell further includes an integral circuit formed on at least one of the casing components.

According to some embodiments of the invention the electrochemical cell further includes an integral circuit formed on at least one of the casing components and wherein the integral circuit forms part of an electronic user device and wherein at least one of the casing components serves as a support of the electronic user device.

According to some embodiments of the invention, at least one of the casing components is flexible, deformable, of a hyper rectangular cuboid shape, of a triangular cylindrical shape, of a hexagonal cylindrical shape, shaped as a cylinder circumscribed by a standard battery cross section, shaped as a cylinder having a cross section with both straight and curved sides, shaped as a cylinder having a circular section cross section, and shaped a cylinder circumscribing a standard battery cross section.

According to some embodiments of the invention the electrochemical cell further includes a second of the casing components made of a conducting material and enclosing a second electrode.

According to some embodiments of the invention, the first casing component is flexible.

According to some embodiments of the invention, the housing fits a standard battery receptacle.

According to some embodiments of the invention the electrochemical cell further includes a label similar to a standard label of the standard battery.

According to some embodiments of the invention, the label includes a non-standard designation and a standard numbering scheme.

According to an aspect of some embodiments of the present invention there is provided a modular electrochemical cell including a mechanically interlocking housing; at least two terminals including an anode terminal and a cathode terminal, a first of the at least two terminals on a first end of the housing and wherein when the mechanically interlocking housing interlocks to a mechanically interlocking housing of second modular electrochemical cell the first terminal makes an electrical connection with one of the at least two terminals of the second electrochemical cell to form a compound battery.

According to some embodiments of the invention, the at least two terminals are located on one side of the modular electrochemical cell.

According to some embodiments of the invention, the interlocking housing is prismatic in shape.

According to some embodiments of the invention, the at least two terminals are configured for forming a series connection when the interlocking housing is interlocked to the second modular electrochemical cell in a first orientation.

According to some embodiments of the invention, the at least two terminals are configured for forming a parallel connection when the interlocking housing is interlocked to the second modular electrochemical cell in a second orientation.

According to some embodiments of the invention the modular electrochemical cell further includes an interconnector for electrically connecting two stacks of the modular electrochemical cells into a single electro motive unit.

According to an aspect of some embodiments of the present invention there is provided a method of manufacture of a battery housing including constructing a housing including an electrically insulating casing component, the housing enclosing a chamber, the chamber including an electrode, the housing including in inside surface facing the chamber and an outside surface; and forming a conductor on a selected area of the electrically insulating casing component, the conductor including a current collector on an inside surface of the electrically insulating casing component and in electrical contact with the electrode, a link transmitting current from an inside surface of the electrically insulating casing component to an outside surface of the electrically insulating casing component, and/or a terminal on an outside surface of the electrically insulating casing component, the terminal connectable to a power drain.

According to an aspect of some embodiments of the present invention there is provided a method of constructing a modular battery including mechanically interlocking a plurality of cells to form a stack and connecting terminals of the cells within the stack to form a compound battery.

According to some embodiments of the invention, the method of constructing a modular battery further includes supplying both an anode terminal and a cathode terminal on one end of the stack.

According to an aspect of some embodiments of the present invention there is provided an integral battery device including an electrically insulating casing component; a housing including the electrically insulating casing component, the housing enclosing a chamber, the chamber including a first electrode and a second electrode, the housing including in inside surface facing the chamber and an outside surface facing away from the chamber; an electrical device supported by the electrically insulating casing component, and an electrical conductor selectively formed on the electrically insulating casing component to produce a current collector on an inside surface of the electrically insulating casing component and in contact with said first electrode and/or a link channeling current from the first electrode to the device.

According to some embodiments of the invention the electrical device includes a conductive layer selectively formed on the electrically insulating casing.

According to some embodiments of the invention the electrical device includes a camera, a remote control unit, a charging circuit, a testing circuit, a current stabilizer, a personal communication device, and/or a battery indicator.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart illustrating a method of manufacturing an electrochemical cell in accordance with an embodiment of the present invention;

FIG. 2 is a flowchart illustrating a method of assembling a compound modular battery in accordance with an embodiment of the present invention;

FIG. 3 is a block diagram illustrating an electrochemical cell in accordance with an embodiment of the present invention;

FIG. 4A is a first disassembled view of an electrochemical cell having a terminal on each end in accordance with an embodiment of the present invention;

FIG. 4B is a second disassembled view of an electrochemical cell having a terminal on each end in accordance with an embodiment of the present invention;

FIG. 4C is an exploded view of an electrochemical cell having a terminal on each end in accordance with an embodiment of the present invention;

FIG. 5A is a first disassembled view of an electrochemical cell having two terminals on one end in accordance with an embodiment of the present invention;

FIG. 5B is a second disassembled view of an electrochemical cell having two terminals on one end in accordance with an embodiment of the present invention;

FIG. 6A is a first perspective view of a modular electrochemical cell in accordance with an embodiment of the present invention;

FIG. 6B is a second perspective view of a modular electrochemical cell in accordance with an embodiment of the present invention;

FIG. 6C is a first perspective view of a parallel compound modular battery in accordance with an embodiment of the present invention;

FIG. 6D is a second perspective view of a parallel compound modular battery in accordance with an embodiment of the present invention;

FIG. 6E is a first perspective view of a series compound modular battery in accordance with an embodiment of the present invention;

FIG. 6F is a second perspective view of a series compound modular battery in accordance with an embodiment of the present invention;

FIG. 6G is a perspective view of a series compound modular battery, showing a schematic electrical connection in accordance with an embodiment of the present invention;

FIG. 6H is a perspective view of a combination series-parallel compound modular battery including an interconnector in accordance with an embodiment of the present invention;

FIG. 7A is perspective view of a prior art button battery;

FIG. 7B is perspective view of a alternative shape for fitting standard button battery receptacle in accordance with an embodiment of the present invention;

FIG. 8A is a perspective view of an exemplary embodiment of a battery with an integral device in accordance with an embodiment of the present invention;

FIG. 8B is a perspective view of an alternative embodiment of a battery with an integral device in accordance with an embodiment of the present invention;

FIG. 9A is a perspective view of an exemplary embodiment of a hexagonal modular cell in accordance with an embodiment of the present invention;

FIG. 9B is a perspective view of a compound modular battery including hexagonal and triangular modular cells in accordance with an embodiment of the present invention;

FIG. 10 is a perspective view of a cylindrical electrochemical cell having a circular section cross section in accordance with an embodiment of the present invention;

FIG. 11A is a perspective view of a disassembled replacement for an AAA cell in accordance with an embodiment of the present invention;

FIG. 11B is a perspective view of an assembled replacement for an AAA cell in accordance with an embodiment of the present invention;

FIG. 12 is a perspective view of an alternative assembled replacement for an AAA cell in accordance with an embodiment of the present invention;

FIG. 13A is a cutaway perspective view of a battery casing in accordance with an embodiment of the present invention including a rough surface current collector and a via link between the inner and outer surfaces of the casing; and

FIG. 13B is a cross sectional view of a battery casing in accordance with an embodiment of the present invention including a rough surface current collector and a via link between the inner and outer surfaces of the casing.

### DESCRIPTION OF SPECIFIC EMBODIMENTS OF THE INVENTION

The present invention, in some embodiments thereof, relates to a multi-component battery casing and, more particularly, but not exclusively, to a plastic battery casing having a novel geometry for a current collector, a current link and/or a terminal.

### Overview

### 1 Battery Casing Having a Selected Conducting Area

An aspect of some embodiments of the current invention relates to a battery casing treated to form electrical conductivity and/or electrical insulation in a selected area. Optionally, a conductive area may form a current collector for an electrode and/or a link to transfer current for example from the interior to the exterior of the casing and/or between an electrode and a terminal and/or to provide an electrical connection to an external device and/or a secondary device, and/or between a first casing and a second casing of the battery housing. The casing material may optionally be rigid or flexible. For example a flexible battery may adapt to a desired volume and/or geometry. For example, a battery casing may be made with Poly Urethane and/or a thermo plastic elastomer. The casing may be softer and/or more flexible than current conductive steel casings. In some embodiments, insulating components may make up for example between 20% and 100% of the battery casing.

In some embodiments the casing may be made of an electrically insulating material and a conducting area may be formed using molded interconnect device (MID) technology. For example MID technology may include multicomponent molding and/or multishot molding and/or hot stamping and/or laser direct structuring (LDS) and/or chemical deposition and/or physical deposition and/or thin film printing and/or a conductive film and/or foil may glued to the casing. For example in LDS a doped thermoplastic material may optionally be molded and/or selectively treated by means of a laser, for example to enable selective metallization of the “laser treated” area. A selected area of a casing may optionally be metalized. A selective coating on plastic may for example have a thickness ranging between 4 to 30 microns. A coating may form a conductive area and/or an insulating area on the surface of the casing. Other methods include, without limitation, coating with metal, laser ablation, non-conductive coating over painting, injection molding (for example “Two-shot-Molding” and/or enabling adhesion of a conductive layer via plating) and/or application of conductive ink and/or many others. Selected zones may optionally be texturized, for example a charge collector may be made rough to increase surface area. Increasing surface area may increase conductive area and/or reduce electrical resistance.

In some embodiments, a housing may enclose a chamber and/or an electrode (for example an anode and/or a cathode) and/or a transport medium (for example a transport medium for ions may include one or more electrolytes and/or a semi permeable membrane). Non-limiting examples of anode, cathode and electrolyte combinations include lithium, manganese dioxide and lithium chlorate; zinc, manganese dioxide and zinc chloride; lithium, thionyl chloride and lithium aluminum chloride, and many others. The anode and/or cathode and/or the transport medium may include for example a solid and/or a liquid and/or a gas and/or a paste and/or a pellet and/or a membrane.

The casing may be self contained and/or joined to other components. For example a battery may include a housing made of two or more joined casing components and/or a single casing may be made of multiple components. For example a battery housing may include an anode casing and a cathode casing joined together. Joining and/or sealing may be by any suitable method, such as but not limited to, thermal bonding, ultrasonic welding, adhesive bonding, snap fit or other joining methods. One or more links may optionally transport current between the inside and outside of a casing and/or from one part of the casing to another part of the casing and/or between casing components. A plurality of links and/or terminals and/or current collectors may be located at separate areas that may optionally be electrically isolated from one another. Optionally a link may be formed as a via passing through from an inner to an outer surface of casing.

In some embodiments of the present invention, a two part dry cell battery (for example similar to a button battery) can be produced without a gasket. Optionally a battery may be produced in any desired shape, such as but not limited to, a prismatic shape (for example a modular battery) and/or cylindrical shape with a circular section cross section (for example for use in watches). In some embodiments of the invention a battery may be one-use (for example disposable) and/or rechargeable and/or regenerable and/or renewable.

### 2 Alternative Geometry Battery

An aspect of some embodiments of the current invention relates to a non standard battery shape battery.

For example, a battery may have a prismatic form and/or may have a cross section forming a circular and or non-circular segment and/or forming a crescent and/or forming a circular and/or non-circular section and/or a cylindrical form with an arbitrary cross section (for example the cross section may have linear and/or curved portions) and/or the battery may have the form of a polyhedron and/or of another arbitrary shape. A battery may optionally have positive and/or negative terminals on opposite sides and/or both on the same side and/or a terminal may be accessible from more than one side of the battery. Optionally, a battery may include built in tabs and/or connecting posts. A battery may be designed, for example, for convenient connection to a printed circuit board (PCB).

In some embodiments, a plastic battery may fit into a standard battery receptacle. The inventor realized that many battery receptacles have extra space. For example, common receptacles for button batteries grasp the battery from only a few points (for example the two ends). A typical such receptacle may have a square cross section and/or may have space for a square battery. Inserting a standard circular cross section button battery circumscribed within the square cross section of the mount may result in a wasting approximately 27% of the space. A square cross sectioned battery according to some embodiments of the present invention may optionally fit the receptacle and have more volume and/or surface area and/or improved performance. Optionally, a standard CR2032 battery may be replaced by a non-standard square battery and a standard numbering scheme, for example “SQR 2032”, which stands for square shape battery, with side length (width) 20 mm and thickness (height) 3.2 mm. The prismatic shape may increase capacity and performance and reduces impedance. For example in some embodiments a SQR2032 may increase performance for example by approximately 27% over a button battery. Other shapes may replace other standard type batteries. For example an AAA battery may be replaced by a square cross section battery and/or by a battery rounded on two sides and squared on two sides, for example as described herein below.

### 3 Modular Cell

An aspect of some embodiments of the current invention relates to a modular cell that can optionally serve as a module of an electromotive unit (for example a compound battery and/or a battery pile). In some embodiments, a modular cell may function on its own as a complete battery. Optionally, a casing of the modular cell may include interlocking features for mechanically interlocking with another modular cell, for example, for constructing compound batteries. Optionally, a battery may include interconnectable terminals and/or links, for example, to produce a series compound battery and/or a parallel compound battery and/or to facilitate location of terminals on various locations of the compound battery. In some embodiments, a mechanical interlocking and an electrical connection may be supplied by a single feature. Alternatively or additionally there may be a feature that provides mechanical interlocking but not electrical connection and/or electrical connection by not mechanical interlocking. In some embodiments terminals and/or geometry of the battery may be designed for convenient connection to a device. For example an anode terminal and a cathode terminal may be accessible from one end of the electromotive unit and/or stack. A compound battery may include an external frame and/or a selectively conducting cap and/or other cooperative elements. The battery cell may also include integrated connecting features, for example as described herein below.

### 4 Integral Battery/Device

An aspect of some embodiments of the current invention relates to using a casing of a battery to form part of a device. For example a casing may include a chamber for an electrode as well as supply mechanical support for a device. For example, a battery casing may also serve as a substrate for a PCB and/or include a chamber for a consumer device (for example a remote control device). A battery casing may optionally include a logic circuit and/or an integrated circuit. The logic circuit may for example control functioning of the battery and/or serve an external function. For example a circuit may include a super capacitor. A capacitor may, for example, provide a current stabilization and/or minimize voltage fluctuations.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

### Exemplary Embodiments

### 1 A Method of Producing a Battery Housing

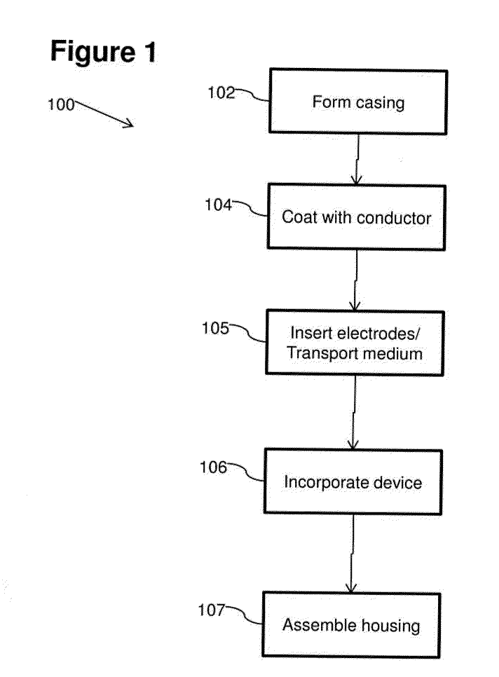

Referring now to the drawings, FIG. 1 is a flow chart illustration of an exemplary embodiment 100 of a method of producing a battery with an electrically insulating casing selectively coated with a conductor in accordance with an embodiment of the current invention.

In some embodiments a battery casing may be formed 102 for example of molded plastic or elastomer. The casing may optionally be part of a housing enclosing a chamber for holding one or more electrodes (for example and anode and/or a cathode) and/or a transport medium (for example an electrolyte and/or a semi-permeable membrane). Portions of the casing may be made conductive 104 for example by coating and/or depositing a conductor and/or by laser activation etc. For example the conductive area may include a current collector over a large interior surface in contact with one of the electrodes and/or the conductive area may form a link transporting current for example from inside the chamber to an outer surface of the casing and/or the conductive area may include a contact on an outer surface of the casing.

In some embodiment, electrodes and/or a transport medium may be inserted 105 into the chamber of the battery. For example a paste anode and/or a semi permeable transport media member may be inserted into a casing to form a half cell.

In some embodiments, a device may be incorporated 106 into the battery. For example, the battery housing may include place for an integrated circuit. For example, the same technology used for forming the current collector, the link and/or the terminal may optionally be used to form additional circuitry. The additional optional circuitry may be connected to the battery for operational use with the battery. Such circuitry (referred here in as “battery circuitry”) may include, without limitation, recharging circuitry, voltage stabilizer, battery status circuitry (with possible additional LEDs) and/or many others. For example, the battery casing could also serve as a casing for an electronic user device such as a remote control unit and/or a flashlight and/or a cellular device. The integral circuitry may form a connection to a printed circuit board (PCB) and/or a PCB may be integrally formed on the battery casing.

In some embodiments, the battery housing may optionally be assembled 107 for example by joining a first half cell casing to a second half cell casing. For example, a first casing may contain one electrode [an anode or a cathode] and/or a transport medium; a second casing may contain the other half cell of the battery. The first half cell may optionally include a non-conductive casing selectively coated with a conductor according to the current invention. The second half cell may optionally include a non-conductive casing selectively coated with a conductor according to the current invention. Alternatively or additionally, the second half cell may optionally include a different kind of casing (for example a conventional conductive metal casing).

In some embodiments, a single casing may be assembled 107 with both cells of the battery. For example, a cathode and/or anode and/or transport medium may be injected into the single chamber. The single chamber may optionally be sealed with a cap and/or a seal. Alternatively or additionally, a battery may use air for an electrode for example with a permeable chamber. Alternatively or additionally, a casing may be coated with a sealing material to protect it from moisture and/or air.

Some embodiments of the present invention may include some of the following potential advantages. Plastic molding technologies may optionally facilitate creating batteries of different geometries and surface topographies. According to some embodiments of the current invention, it may be possible to produce two part prismatic batteries that seal without a gasket. In some embodiments of the present invention it may be possible to place terminals in strategic locations on a battery, for example the anode and cathode terminals may be on the same end of a two part dry cell battery and/or one side may include an anode and a cathode while the other side contains either an anode or a cathode so that the battery may be connect from only one side and/or from both sides. In some embodiments the casing of the battery may be molded to serve also as a substrate for a device having an integral battery.

### 2 A Method of Constructing a Modular Battery

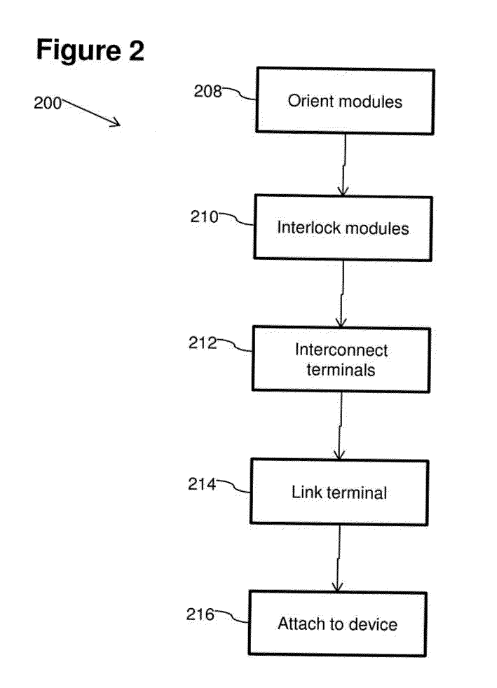

Referring now to the drawings, FIG. 2 is a flow chart illustration of an exemplary embodiment 200 of a method of assembling a compound modular battery in accordance with an embodiment of the current invention. For example, modular cells may be provided with mechanically interlocking features. The compound battery may be assembled by mechanically interlocking the modular cells together. Terminals of the modular cells may be interconnected to form a compound battery.

In some embodiments, modular battery elements may have different interconnection modes. For example the modules may be oriented 208 in one way for a parallel connection and another way for a series connection.

In some embodiments, modular cells may have mechanically interlocking features. For example the modular cells may be made like Lego® blocks that can be interlocked 210 in various geometries. Interlocking features may be built into the battery housing and/or the terminals and/or both and/or in other parts. Terminals of the modular cells may be interconnected 212 to form a compound battery. For example, interconnection terminals may be provided that interconnect 212 the modular cells in parallel when the cells are oriented in one geometry and to interconnect 212 the modular cells in series when the cells are oriented an opposing geometry.

In some embodiments, links may optionally be provided to link 214 a collective cathode and/or anode to a collective terminal. The collective terminals may, optionally, be provided at a convenient location. For example both the cathode and the anode collective terminals may be located on one end of a stack of cells. Optionally, the cells may be interconnected in series and/or in parallel and/or in a combination (for example multiple groups containing a few cells in series may be constructed and the groups may be connected in parallel into a large compound battery). Optionally, the collective terminals may be configured for convenient attachment 216 to a device, for example a printed circuit board (PCB). For example the terminals may include a solder tab and/or quick connectors and/or pressure connectors and/or spring connectors and/or pin connectors and the like.

### 3 A Schematic Geometry of a Battery

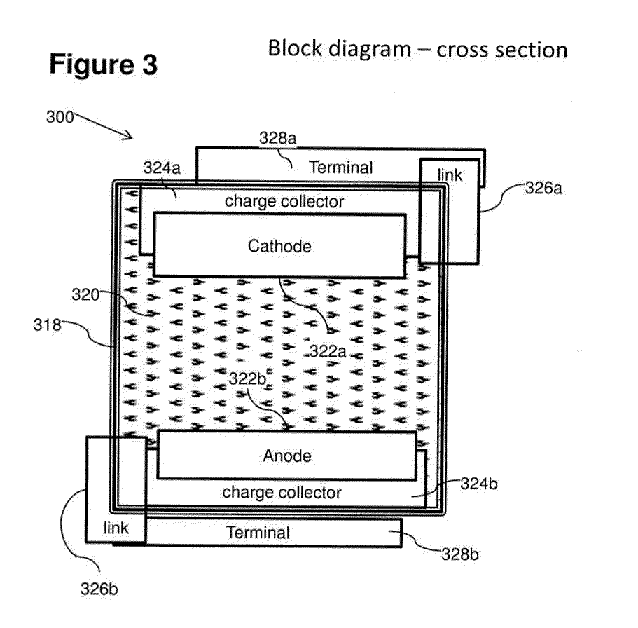

Referring now to the drawings, FIG. 3 is a schematic illustration of an exemplary embodiment 300 of a battery made with an electrically insulating casing including selected conducting areas in accordance with an embodiment of the current invention.

In some embodiments, a battery housing may include an electrically insulating casing 318. A chamber in casing 318 may contain one or more electrodes, for example a cathode 322a and/or an anode 322b separated by a transport medium 320. In embodiment 300, transport medium 320 may include, for example, one or more electrolytes and/or a permeable membrane. An electrically conducting charge collector may be in contact with each electrode. For example in embodiment 300, a cathode collector 324a and an anode collector 324b may be supplied on the inner surface of casing 318. The charge collector may contact an electrode over a surface.

In some embodiments, a link (for example links 326a,b) may provide electrical connection between an inside and outside surface of casing 318. For example, links 326a,b connect charge collectors on an inside surface of casing 318 (for example collectors 324a,b) to terminals (for example terminals 328a,b) on an outside surface. Links 326a,b and/or terminals 328a,b may optionally be formed on a surface of casing 318. For example, links 326a,b may be formed on an inside surface and outside surface, winding around and/or through the casing 318. Terminals 328a,b may, for example, be formed to an outside surface of casing 318.

In some embodiments, the surface of contact between charge collectors 324a,b and the electrodes may be maximized. (For example the surface of contact may be rough. For example the inner surface of the chamber may have ridges and/or waves such that the charge collectors 324a,b that are formed thereon have ridges and/or waves that increase the roughness and/or the contact area between the charge collector and the electrode). Increased area of contact between the electrode and the charge collector may increase the current output of the battery.

The geometry of casing 318, charge collectors 324a,b, links 326a,b and/or terminals 328a,b may be formed in a convenient geometry to avoid short circuiting and/or to provide convenient terminals for connection to a device and/or to fit efficiently in an available space.

### 4 An Exemplary Embodiment of a Two Part Prismatic Battery

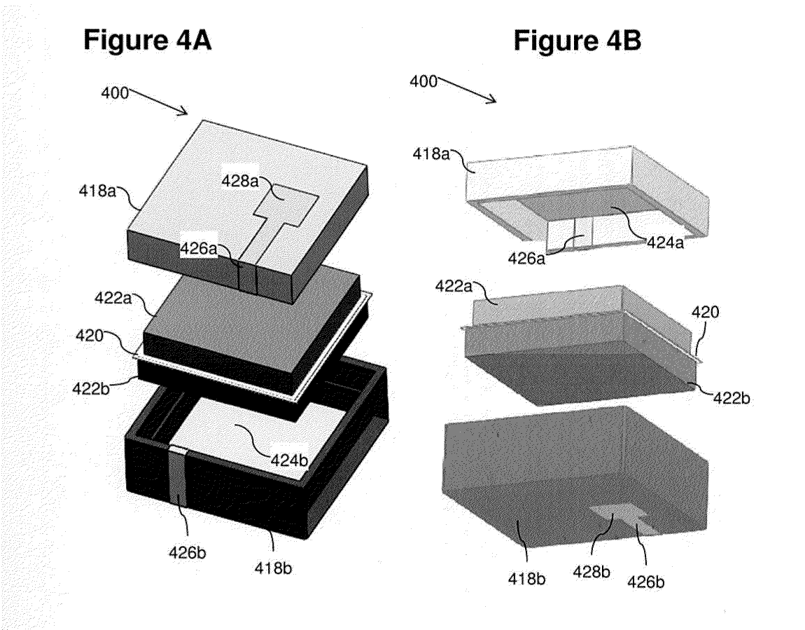

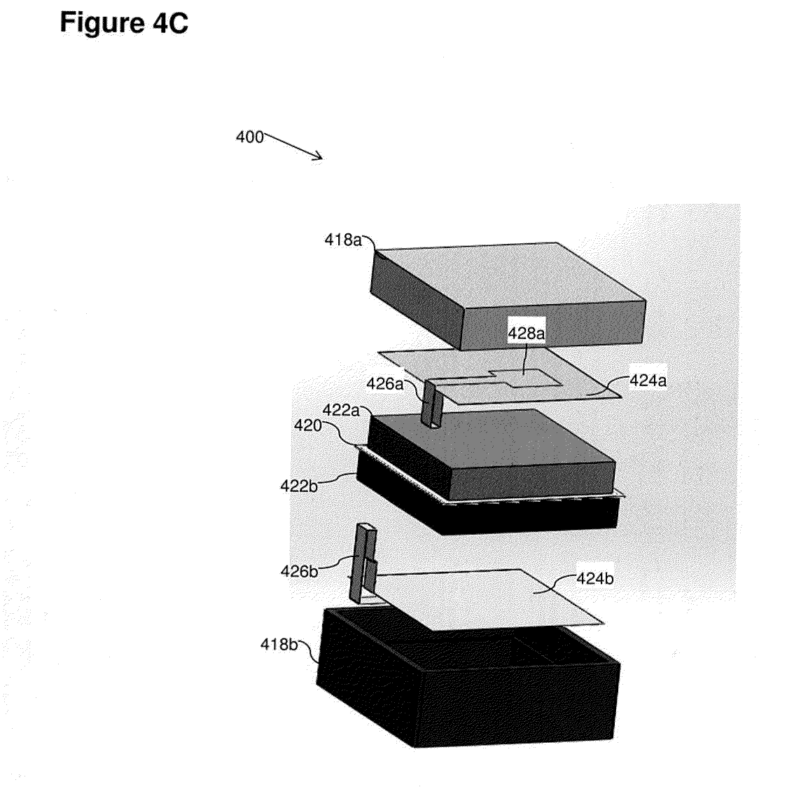

Referring now to the drawings, FIGS. 4A-C illustrate of an exemplary embodiment 400 of a prismatic battery in accordance with an embodiment of the current invention. The casing for a prismatic battery may be constructed for example of plastic in a convenient geometry, for example by injection molding. Current collectors and/or links and/or terminals for the prismatic battery may be formed on the surface of the plastic casing. For example a link may transport current from the inside surface of the casing across an edge to an outside surface. The anode and cathode links may be configured to prevent short circuiting. The prismatic battery may optionally not include a gasket.

Exemplary embodiment 400 of a prismatic battery includes a cathode (positive electrode 422a) and/or an anode (negative electrode 422b) in a chamber enclosed within casings 418a,b. Electrodes 422a,b may optionally be formed of a paste and/or have a prismatic shape (e.g., square or rectangular). A transport medium 420 may optionally include an electrolyte and/or a separator (for example a semi permeable membrane) which optionally separate positive electrode 422a from negative electrode 422b and/or allow transport of ions between electrodes 422a,b. Electrodes 422a,b and transport medium 420 are optionally housed in an electrically insulating housing (e.g., plastic housing) that includes a cover (for example a cathode casing 418a) and a base (for example an anode casing 418b). A cathode upper terminal 428a and/or link 426a and/or terminal 428a may optionally be deposited, coated or otherwise formed on an outer surface of cathode casing 418a. Terminal 428a may be electrically connected, for example, to anode 422a via link 426a and/or charge collector 424a. For example, link 426a may run from terminal 428a along the outer surface of casing 418a (as illustrated in FIG. 4A) across an edge of casing 418a and along the inner surface of casing 418a (for example as illustrated in FIG. 4B). An anode lower terminal 428b and/or link 426b and/or charge collector 424b may optionally be deposited, coated or otherwise formed on an outer surface of anode casing 418b. Terminal 428b may be electrically connected, for example, to anode 422b via link 426b and/or charge collector 424b. Links 426a and 426b are offset from one another so that they do not contact each other to short the battery.

In the battery of the present invention, a gasket is optionally not required.

FIG. 4C is an exploded view of exemplary embodiment 400 of a prismatic battery. In FIG. 4C, for illustrative purposes, the exemplary cathode conductive areas including terminal 428a, link 426a and charge collector 424a are illustrated separate from casing 418a on which they are formed. In FIG. 4C, for illustrative purposes, the exemplary anode conductive areas including terminal 428b, link 426b and charge collector 424a are illustrated separate from casing 418a on which they are formed.

### 5 Alternative Contacts for a Battery

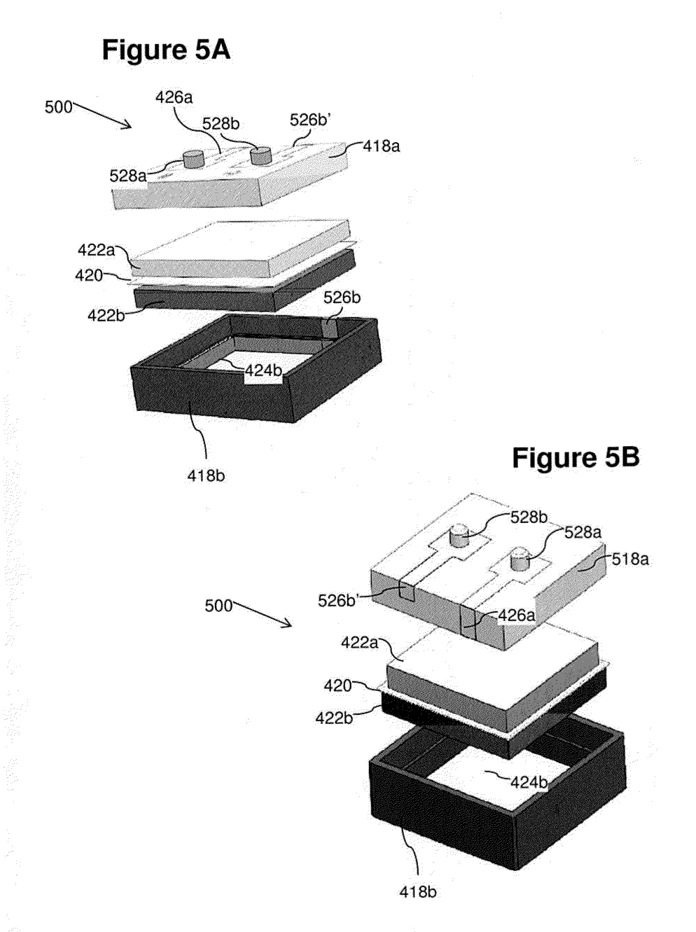

FIGS. 5A-B illustrate an exemplary embodiment 500 of a prismatic battery having an alternative contact geometry in accordance with an embodiment of the current invention. Optionally, both cathode terminal 528a and anode terminal 528b are located on the same side of the battery (for example on the cover and/or cathode casing 518a). Embodiment 500 includes, for example, built in soldering tabs. The geometry of embodiment 500 may for example be convenient for attaching to a printed circuit board (PCB).

In some embodiments, a link (for example anode link 526b) will remain on the inside surface of a casing (for example anode casing 418b). A corresponding link on the opposite casing (for example link 526b′ on cathode casing 418a) may optionally contact and/or supply electrical connection from link 526b to anode terminal 528b on cathode casing 518a. In exemplary embodiment 500, terminals 528a,b include optional soldering tabs. Other components of embodiment 500 (for example electrodes 422a,b, transport medium 420, charge collector 424b, casings 418a,b may optionally be similar to corresponding structures of embodiment 400.

### 6 A Modular Battery

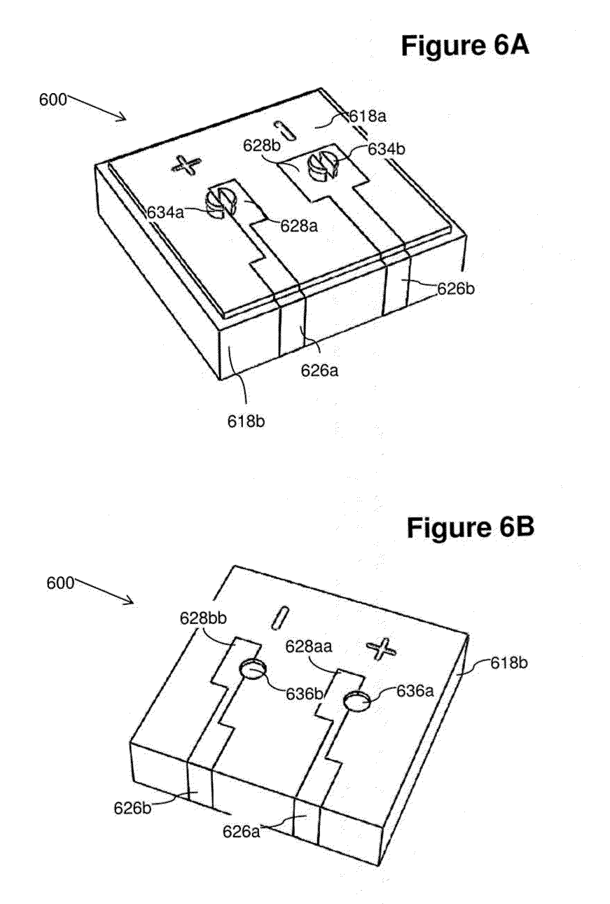

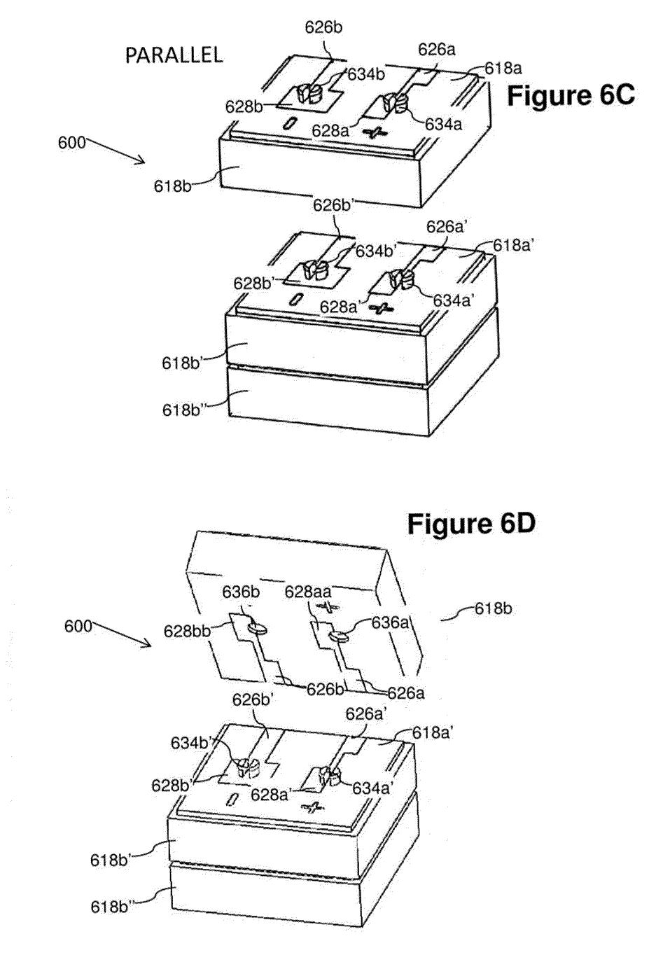

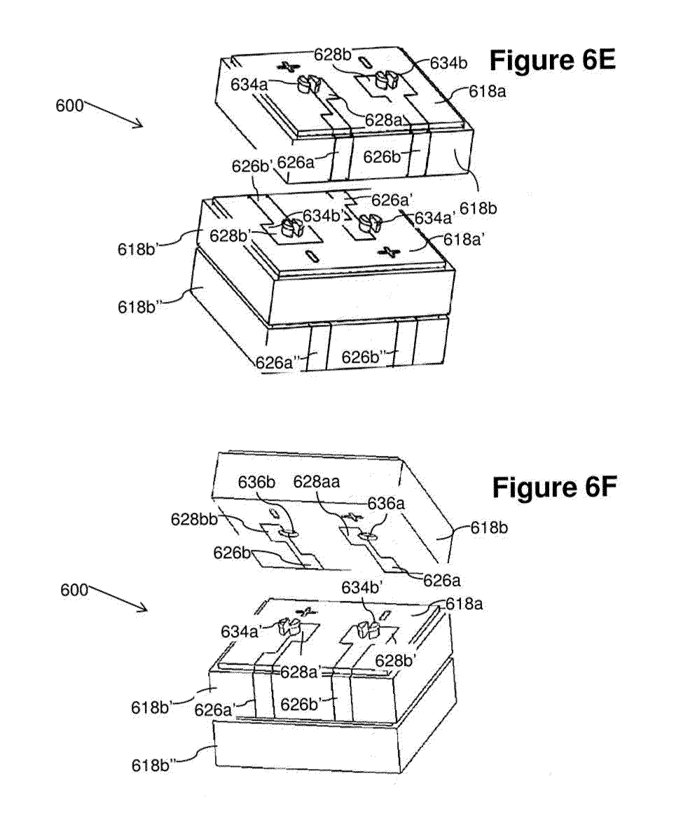

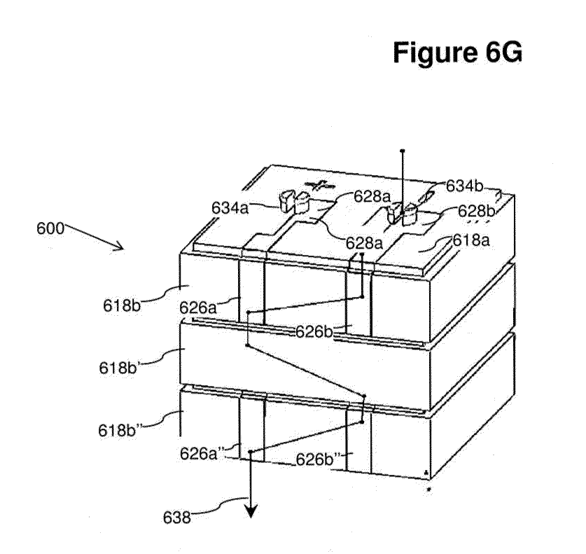

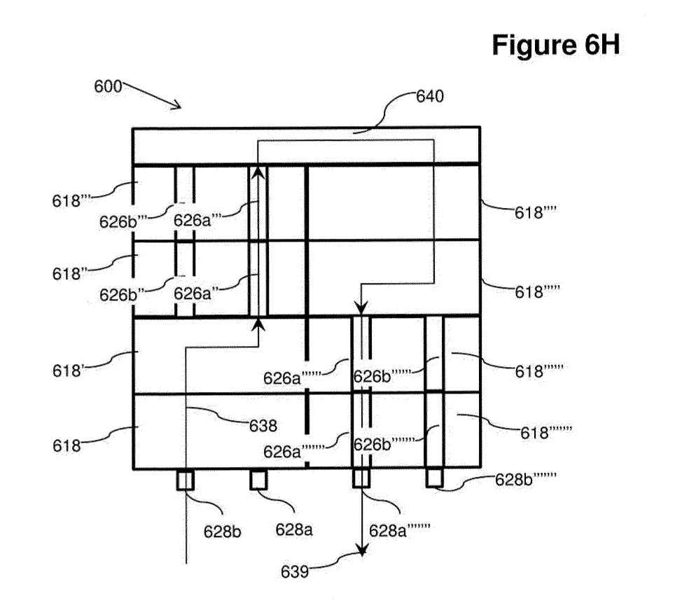

FIGS. 6A-6H illustrate an alternate exemplary embodiment 600 of a prismatic modular cell and examples of modular parallel and series battery stacks in accordance with an embodiment of the current invention. FIG. 6A illustrates a view of two sides of a single modular cell. The modular cell of exemplary embodiment 600 optionally includes a cathode terminal 628a and an anode terminal 628b on the cathode casing 618a and a cathode terminal 628aa and an anode terminal 628bb respectively on the anode casing 618b. Terminals 628a,b include locking buttons 634a,b and terminals 628aa,bb include optional locking holes 636a,b such that when modular cells of embodiment 600 are stacked (for example as illustrated in FIGS. 6C-G) the cells are mechanically interlocked and/or are held together, for example like Lego® blocks. Terminals 628a,aa,b,bb are designed such that when stacked in the same orientation (for example as illustrated in FIGS. 6C,D) they form a parallel stack compound battery and when they are stacked in an alternating orientation they form a series stack compound battery (for example as illustrated in FIGS. 6E,F,G). Links 626a,b connect cathode terminals 628a,aa and anode terminals 628b,bb on both sides of each cell to a corresponding electrode charge collector (for example like anode terminals 528b,bb to anode collector 424b and/or cathode terminals 528a,aa to cathode collector 424a (see FIG. 5A or 5B).

FIGS. 6C and 6D illustrate a parallel stack of cells of exemplary embodiment 600. As illustrated in FIG. 6C, cells of exemplary embodiment 600 are optionally designed such that an interlocking stack of cells all having the same orientation forms a parallel stack battery. In FIGS. 6C-G, a part number with an apostrophe represents the same part as the number without the apostrophe, but on a battery lower in the stack. For example number of anode casing 618b of the first battery in the stack has no apostrophe. The same number with an added apostrophe is the anode casing 618b′ of the second battery in the stack. Adding another apostrophe gives number of the anode casing 618b″ of the third battery in the stack etc. The naming convention applies, for example, to buttons 634a,b,a′,b′ and links 626a,b,a′,b′,a″,b″.

In some embodiments of a parallel stack, as illustrated for example in FIG. 6D the cathode terminal 628aa, on the anode casing 618b of a first battery is connected to the cathode terminal 628a′ on the cathode casing 618a′ of the next battery in the stack. In some embodiments of a parallel stack, the anode terminal 628bb on the anode casing 618b of a first battery is connected to the anode terminal 628b′ on the cathode casing 618a′ of the next battery in the stack.

FIGS. 6E-G, illustrate a series stack of cells of exemplary embodiment 600. As illustrated in FIG. 6E, cells of exemplary embodiment 600 are optionally designed such that an interlocking stack of cells having alternating orientations form a series stack battery.

In some embodiments of a series stack, as illustrated for example in FIG. 6F the cathode terminal 628aa, on the anode casing 618b of a first battery is connected to the anode terminal 628b′ on the cathode casing 618a′ of the next battery in the stack. In some embodiments of a series stack, the anode terminal 628bb on the anode casing 618b of a first battery does not connect to the cathode terminal 628a′ on the cathode casing 618a′ of the next battery in the stack (otherwise, in some embodiments, connecting both the anode and cathode terminals of a pair of batteries may produce a short circuit). Alternatively or additionally, the half connections and full connections may be reversed or designed in another convenient manner to provide two parallel connections when connected in parallel and a single series connection when connected in series. For example, the terminals of embodiment 600 are configured such that each cathode terminal 628a,aa and one of the anode terminals 628bb are half cut out. When stacked in parallel, the half terminals interconnect, but when stacked in alternating series, cut out portions insulate the half terminals from each other. In exemplary embodiment 600 the anode terminals 628b and 628b′ on the cathode casings 618a and 618a′ are a full section. Whether stacked in parallel (the same orientation for example as illustrated in FIGS. 6B,C) or in series (opposite orientations FIGS. 6D-G) the full section anode terminals 628b,b′ connect to cathode terminals (for example anode terminal 628b′ to cathode terminal 628aa) of the next cell. FIG. 6G schematically illustrates the form of the schematic electrical connection 638 in a series stack of cells according to embodiment 600. The combination cathode terminal 628a″ (not shown, but connected to link 626a″) of the exemplary stack of FIG. 6G is on the bottom of the stack while the combination anode terminal 628b is on the top of the stack.

FIG. 6H illustrates a combination interlocked stack of eight cells (delimitated by their casings 618, 618′, 618″, 618′″, 618″″, 618′″″, 618″″″, 618′″″″) of embodiment 600. In the example of FIG. 6H, the eight cells are formed into four pairs stacked in parallel (in the example a first pair of casings 618 and 618′, a second pair of casings 618″ and 618′″, a third pair three casings 618″″ and 618′″″, pair four casings 618″″″ and 618′″″″) and the pairs are connected in series. The result is two combined stacks, each combined stack including two parallel stacks connected in series. For example, the parallel stack of casings 618 and 618′ is connected in series to the parallel stack of casings 618″ and 618′″. For example, the parallel stack of casings 618″″ and 618′″″ is connected in series to the parallel stack of casings 618′″″ and 618′″″″. The two side by side combined stacks of four cells are optionally connected in series and/or mechanically interlocked by an interconnector, for example an interconnector 640. Interconnector 640 makes a stack of eight cells out of two side by side stacks of four cells. The schematic electrical connection 639 of the compound battery illustrates, that with interconnector 640 the combination cathode terminal 628a′″″″ and combination anode terminal 628b are both on the same end of the compound battery. Having both end combination terminals on the same side of the compound battery may be useful, for example when connecting a compound battery to a printed circuit board PCB or other device. Alternately or additionally, interconnector 640 can be used to produce a parallel stack (for example by reversing the orientation of one of the stacks). The schematic electrical connection 639 of the stack is illustrated by arrows. Some of the links 626b″, 626b′″, 626a″, 626a′″, 626b″″″, 626b′″″″, 626a″″″, 626a′″″″ are also illustrated.

Alternative embodiments of interconnectors may include one or more terminals and/or connect arbitrary numbers of stacks. For example a square cover may interconnect four stacks etc. A collection of battery stacks may optionally include interconnectors on one and/or both ends.

### 7 A Prismatic Replacement for a Standard Button Battery

A battery in accordance with the current invention may in some embodiments fit a receptacle of a convention battery. For example a conventional button battery may be replaced by a prismatic plastic battery having similar dimensions.

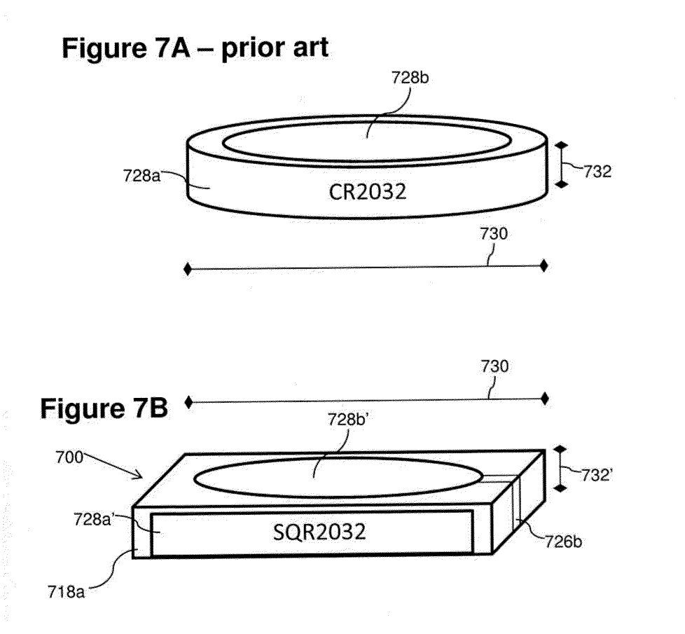

For purposes of better understanding some embodiments of the present invention, as illustrated in FIG. 7B of the drawings, reference is first made to the construction and operation of a conventional CR2032 button battery as illustrated in FIG. 7A.

A typical prior art coin-shaped button battery, for example as illustrated in FIG. 7A, may include a disk shape outer casing 728a (a can) which also serves as a cathode terminal The can may contain a disc-shaped anode pellet and a cathode pellet facing each other with a transport medium containing for example a separator and/or an electrolyte between them. A second casing 728b may include an anode cap. Casings 728a,b form the battery housing. The interface between casings 728a,b may be caulked with an insulation sealing gasket. The anode pellet may be lithium or a lithium alloy or zinc and the cathode pellet may be manganese dioxide or silver dioxide accordingly, for example. The label of the battery may indicate its shape (for example a CR2032 battery has a width 730 (diameter) of 20 mm and a height 732 (thickness) of 3.2 mm.

An exemplary embodiment 700 of a prismatic plastic battery according to some embodiments of the current invention is illustrated in FIG. 7B. In some embodiments, the prismatic shape may increase capacity and/or performance and/or reduce impedance. For example embodiment 700 has 27% more surface area and volume than a similarly sized coin battery (for example as illustrated in FIG. 7A) that may be inscribed therein. In some embodiments, the increase surface area and volume may lead to increased rated current and/or increased battery life. The prismatic shape may optionally include integrated connecting and/or mechanically interlocking features, for example as described above. The battery of the present invention may optionally use the battery code, for example, “SQR 2032”, which stands for square shape, width 730 of 20 mm and height 632′ of 3.2 mm. Embodiment 700 may include for example a insulating cathode casing 718a and/or a cathode terminal 728a′ and/or an anode terminal 728b′. For example anode terminal 728b′ may be formed on cathode casing 718a. Anode terminal may optionally be connected to an anode current collector by an anode link 726a.

### 8 Integral Devices

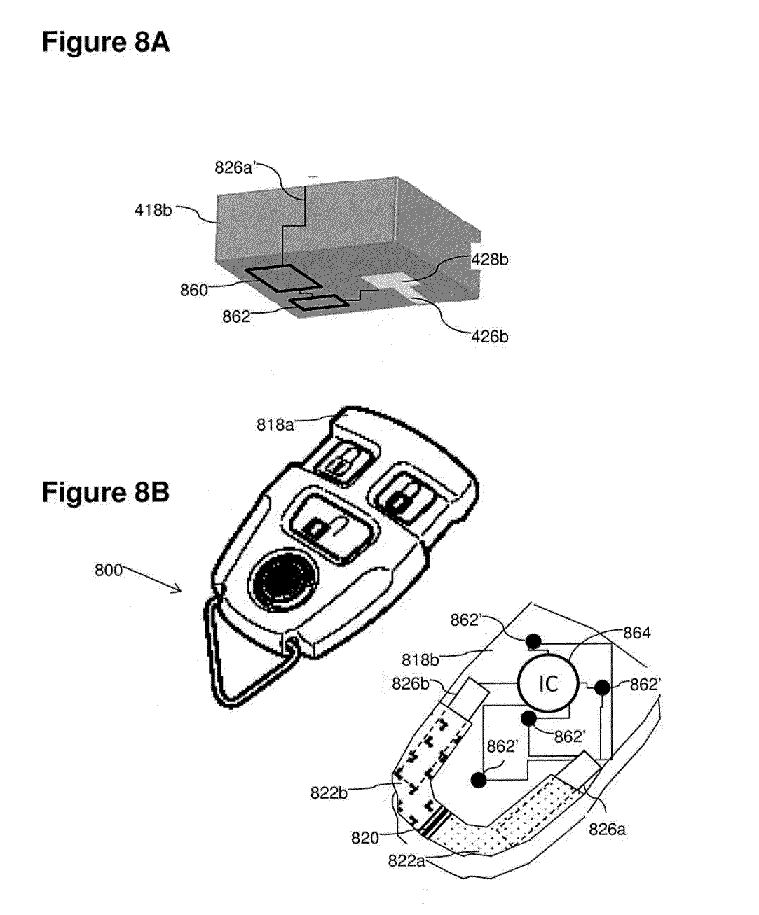

In some embodiments, a casing for a battery may serve as a substrate for an electronic circuit and/or a user device in accordance with an embodiment of the current invention. For example, as shown illustrated in FIG. 8A, battery circuitry 860 may be formed on the outside of anode casing 418b or on a printed circuit layer mounted on the inside and/or outside of the casing 418a and/or on the inside and/or outside of casing 418b or similarly for other embodiments. Battery circuitry 860 may be electrically connected to the terminal 428b via a switch 862. For example, when it is desired to charge the battery, switch 862 is used to electrically connect the battery contacts to battery circuitry 860. Switch 862 may be external or internal to the battery housing. A link 826a′ may optionally connect circuitry 860 to link 428a.

An alternative embodiment 800 of an integral battery device in accordance with an embodiment of the current invention is shown in FIG. 8B. Embodiment 800 for example includes a car lock remote control with an integral battery. The remote control includes a top casing 818a and a bottom casing 818b. The battery includes a positive electrode 822a and a negative electrode 822b separated by a transport medium 820 (for example a semi permeable membrane) inside a chamber molded into casing 818b of the remote control unit. A cathode charge collector and/or link 826a and/or an anode charge collector and/or link 826b may optionally be formed on casing 818b. A circuit of a user device, for example the remote control unit may be supported by casing 818b. For example, an integrated circuit 864 and/or switches 862′, may be manufactured and mounted onto casing 818b and/or inserted into a chamber of casing 818b. Alternatively or additionally, metal layers may be formed on casing 818b to construct an integrated circuit 864 and/or switches 862′ supported by casing 818b.

### 9 Alternative Battery Shapes

The battery may be produced in any desired shape, such as but not limited to, a cylinder with a circular segment cross section for example for watches, and/or prismatic shapes for example for modular applications.

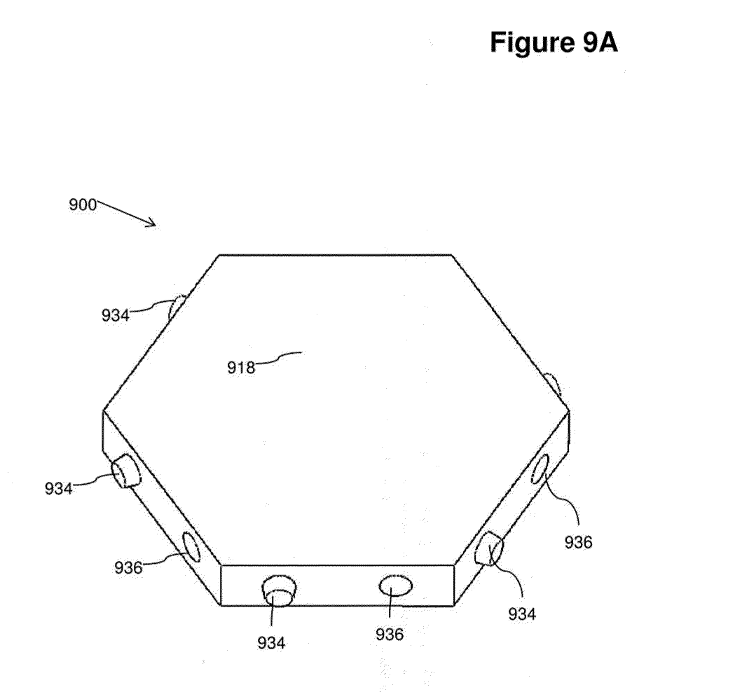

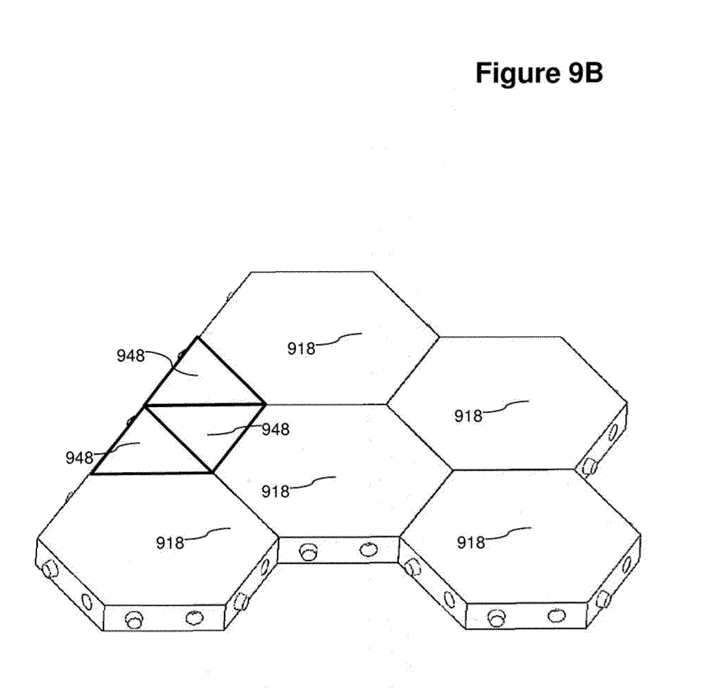

For example FIG. 9A illustrates and exemplary embodiment 900 of a cell having a hexagonal casing 918 in accordance with an embodiment of the current invention. The Hexagonal shaped cell may include mechanically interlocking features such as buttons 934 and/or holes 936. Terminals may be formed on the cells in various useful configurations. The hexagonal cells may be used to cover surfaces for example as illustrated in FIG. 9B. Alternatively and/or additionally, square, rectangular and/or triangular batteries 948 may be provided that also interlock and/or interconnect with the hexagonal batteries.

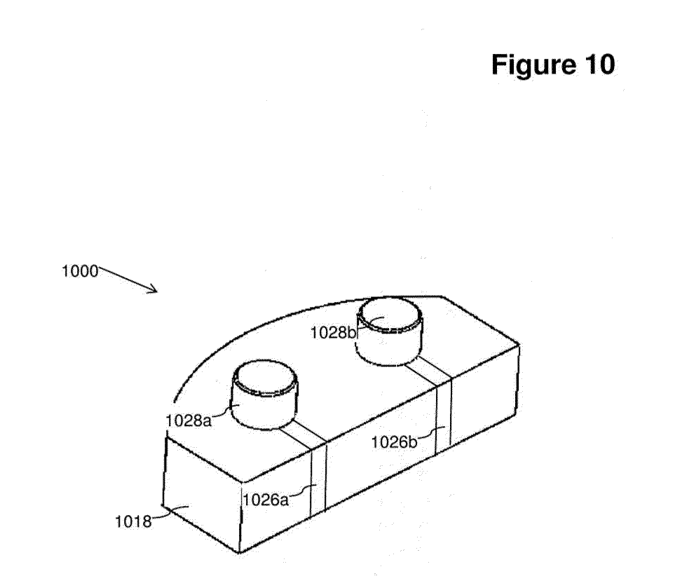

For example FIG. 10 illustrates an embodiment 1000 of a battery with a circular section casing 1018 that may conveniently fit into a watch case in accordance with an embodiment of the current invention. Embodiment 1000 may optionally include protruding cathode and anode terminals 1028a,b respectively connected to their respective electrodes for example by links 1026a,b formed on casing 1018. Alternatively or additionally, links 1026a,b may also serve as terminals.

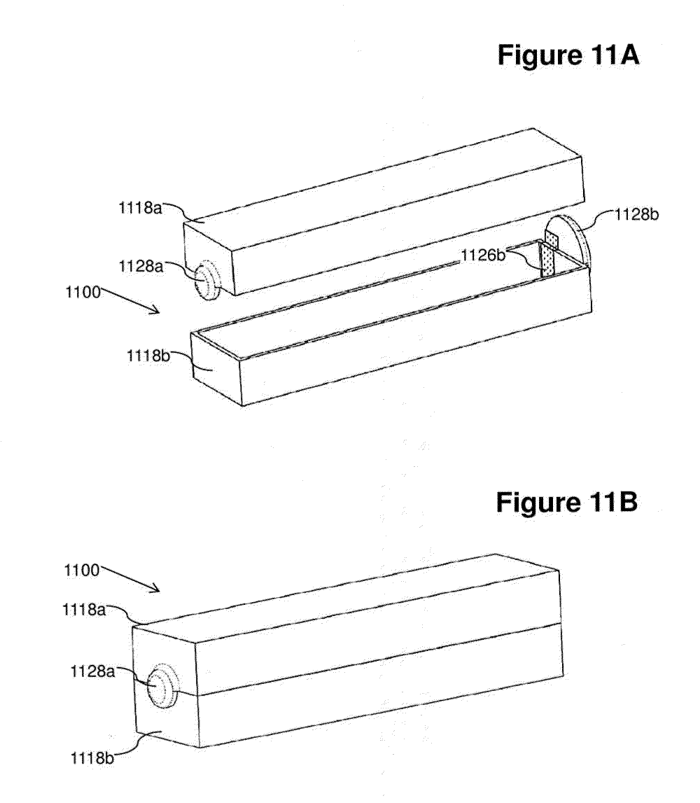

For example, FIGS. 11A and 11B illustrate an exemplary embodiment 1100 of housing for a prismatic battery that may fit some receptacles for AAA sized standard battery. For example, embodiment 1100 is a square cross section cylindrical battery that may fit into some AAA battery receptacles.

In exemplary embodiment 1100 two plastic casings 1118a,b are configured to be joined together to construct a housing as illustrated in FIG. 11B. Optionally, embodiment 1100 is sized such that a standard AAA cell may be inscribed inside the outer boundary of the prismatic cell. Terminals 1128a,b may optionally fit AAA battery standards. Embodiment 1100 may optionally fit into some standard AAA battery mountings. Casings 1128a,b may optionally include a current collector, a link and/or a terminal formed on the plastic, for example link 1126b. The square cross sectioned embodiment 1100 may optionally have a volume that is 27% greater than the volume of a standard (circular cross sections) AAA battery that can be inscribed therein. In some embodiments, the larger volume battery may include a correspondingly larger surface area for current collection and/or larger electrodes than a circular cross section, standard AAA battery. Embodiment 1100 may optionally have a correspondingly larger power and/or energy capacity than a circular cross section, standard AAA battery.

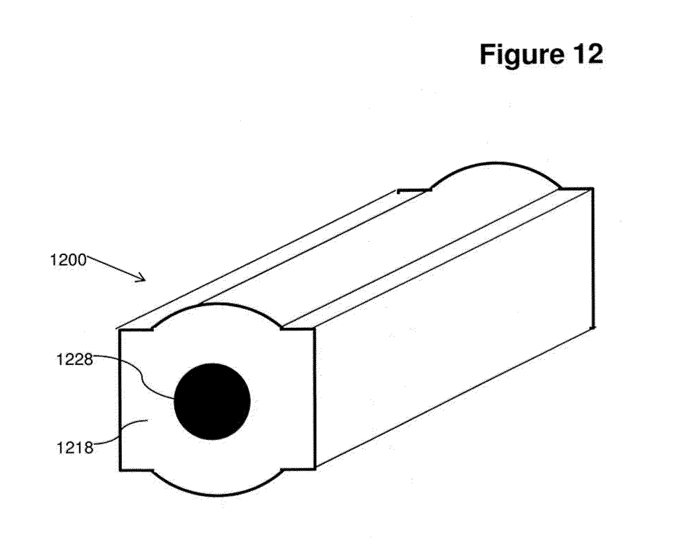

For example FIG. 12 illustrates an exemplary embodiment 1200 of a plastic housing 1218 for a replacement for an AAA sized battery in accordance with an embodiment of the current invention. Housing 1218 has a cylindrical shape with a non-circular cross section that has two flat sides and a rounded top and bottom. Housing 1218 may optionally include a current collector, a link and/or a terminal formed on the plastic. Optionally, embodiment 1200 is sized such that a standard AAA cell may be inscribed inside the outer boundaries of housing 1218. Terminals, for example terminal 1228 may optionally fit AAA battery standards. Embodiment 1200 may for example be used in for example common devices having a battery chamber for an AAA battery that has a rounded guide on two the top and bottom but not on the sides. Embodiment 1200 may have a larger power and/or energy capacity than a circular cross section, standard AAA battery that may be circumscribed by housing 1218.

### 10 A Roughened Contact Surface and a Via Link

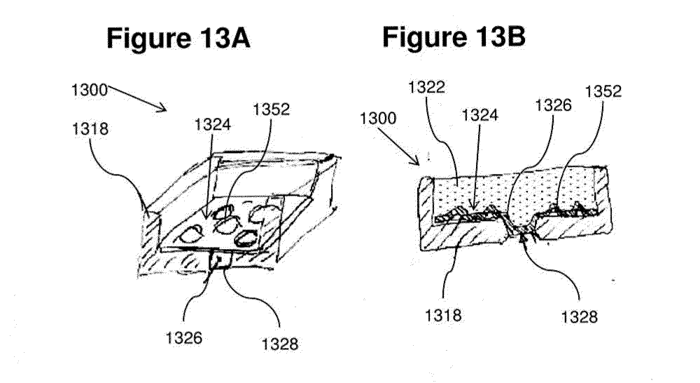

FIGS. 13A and 13B illustrate a perspective cutaway view and a cross sectional view respectively of a battery casing in accordance with an embodiment 1300 of the current invention including an optional roughened contact surface current collector and an optional via link transporting current from an inside surface of the casing to an outside surface of the casing.

Exemplary embodiment 1300 includes an electrically insulated battery casing 1318 with bumps 1352 on and internal surface and a hole passing through the base of the casing. A conductive coating is stamped onto the inner surface of the base of the casing to form a current collector 1324 and a link 1326 passing through the hole to a terminal 1328 on the outside of the battery. Bumps 1352 may increase the area of contact between current collector 1324 and an electrode 1322. Increasing the area of contact may increase the current produced by the cell and/or reduce the internal resistance.

It is expected that during the life of a patent maturing from this application many relevant materials and/or selective coatings will be developed and the scope of the terms formed, coated, and/or deposited are intended to include all such new technologies a priori.

As used herein the term “about” refers to ±5%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. An electrochemical cell, comprising:
a housing including;
one or more casing components; said housing enclosing a chamber, said chamber containing a first electrode, each of said casing components having an inside surface facing said chamber and an outside surface facing away from said chamber;
a first of said casing components made of an electrically insulating material, and
one or more electrically conducting areas selected from the group consisting of
a current collector contacting said first electrode and formed on said inside surface of said first casing component,
a first link including an interior portion formed on said inside surface of said first casing component and an exterior portion formed on said outside surface of said first casing component and an electrical connection between said interior portion and said exterior portion, and
a terminal formed on said outside surface of said first casing components, said terminal connectable to a power drain.

2. The electrochemical cell of claim 1, further comprising:
a transport medium disposed between said first electrode and a second electrode.

3. The electrochemical cell of claim 1, further comprising:
a second electrode in electrical connection with
a second link, said second link including a second interior portion formed on said inside surface of said first casing component and a second exterior portion formed on said outside surface of said first casing component and an electrical connection between said interior portion and said exterior portion and wherein said first link and said second link have a geometry avoiding shorting.

4. The electrochemical cell of claim 1, further comprising:
a second of said casing components made of an electrically insulating material; and
a second electrode in electrical connection with a second link, said second link including a second interior portion formed on said inside surface of said second casing component and a second exterior portion formed on said outside surface of said second casing component and an electrical connection between said interior portion and said exterior portion and wherein said first link and said second link have a geometry avoiding shorting.

5. The electrochemical cell of claim 1, wherein said housing has mechanically interlocking features.

6. The electrochemical cell of claim 5, wherein said terminal is configured for forming a series connection upon said stacking in a first orientation.

7. The electrochemical cell of claim 6, wherein said terminal is configured for forming a parallel connection upon said stacking in a second orientation.

8. The electrochemical cell of claim 5, further comprising:
an interconnector for electrically connecting two stacks of the electrochemical cells into a single electro motive unit.

9. The electrochemical cell of claim 1, further comprising:
an integral circuit formed on at least one of said casing components.

10. The electrochemical cell of claim 1, further comprising:
an integral circuit formed on at least one of said casing components and wherein said integral circuit forms part of an electronic user device and wherein at least one of said casing components serves as a support of said electronic user device.

11. The electrochemical cell of claim 1, wherein at least one of said casing components has at least one property selected from the group consisting of flexible, deformable, hyper rectangular cuboid, triangular cylinder, hexagonal cylinder, cylinder circumscribed by a standard battery cross section, a cylinder having a cross section with both straight and curved sides, a cylinder having a circular section cross section, and a cylinder circumscribing a standard battery cross section.

12. The electrochemical cell of claim 1, further comprising
a second of said casing components made of a conducting material and enclosing a second electrode.

13. The electrochemical cell of claim 1, wherein said first casing component is flexible.

14. The electrochemical cell of claim 1, wherein said housing fits a standard battery receptacle.

15. The electrochemical cell of claim 14, further comprising:
a label similar to a standard label of said standard battery.

16. The electrochemical cell of claim 15, wherein said label includes a non-standard designation and a standard numbering scheme.

17. The electrochemical cell of claim 1, wherein said first link supplies an electrical connection between said first casing component of said housing and a second casing component of said housing.

18. A modular electrochemical cell comprising:
a mechanically interlocking housing;
at least two terminals including an anode terminal and a cathode terminal, and
wherein when said mechanically interlocking housing interlocks to a mechanically interlocking housing of second modular electrochemical cell a first terminal of said at least two terminals makes an electrical connection with one of said at least two terminals of said second electrochemical cell to form a compound battery.

19. The modular electrochemical cell of claim 18, wherein said at least two terminals are located on one side of the modular electrochemical cell.

20. The modular electrochemical cell of claim 18, wherein said interlocking housing is prismatic in shape.

21. The modular electrochemical cell of claim 18, wherein said at least two terminals are configured for forming a series connection when said interlocking housing is interlocked to said second modular electrochemical cell in a first orientation.

22. The modular electrochemical cell of claim 21, wherein said at least two terminals are configured for forming a parallel connection when said interlocking housing is interlocked to said second modular electrochemical cell in a second orientation.

23. The modular electrochemical cell of claim 18, further comprising:
an interconnector for electrically connecting two stacks of said modular electrochemical cells into a single electro motive unit.

24. A method of manufacture of a battery housing comprising:
constructing a housing including an electrically insulating casing component, said housing enclosing a chamber, said chamber including an electrode, said housing including in inside surface facing said chamber and an outside surface; and
forming a conductor on a selected area of said electrically insulating casing component, said conductor comprising at least one part selected from the group consisting of
a current collector on an inside surface of said electrically insulating casing component and in electrical contact with said electrode,
a link transmitting current from an inside surface of said electrically insulating casing component to an outside surface of said electrically insulating casing component, and
a terminal on an outside surface of said electrically insulating casing component, said terminal connectable to a power drain.

25. A method of constructing a modular battery comprising:
mechanically interlocking a plurality of cells to form a stack;
connecting terminals of said plurality of cells within said stack to form a compound battery.

26. The method of claim 25, further comprising:
supplying both an anode terminal and a cathode terminal on one end of said stack.

27. An integral battery device comprising:
an electrically insulating casing component;
a housing including said electrically insulating casing component, said housing enclosing a chamber, said chamber including a first electrode and a second electrode, said housing including in inside surface facing said chamber and an outside surface facing away from said chamber;
an electrical device supported by said electrically insulating casing component, and
an electrical conductor selectively formed on said electrically insulating casing component to produce one or more of
a current collector on an inside surface of said electrically insulating casing component
a link channeling current from said first electrode to said electrical device.

28. The integral battery device of claim 27, wherein said electrical device includes a conductive layer selectively formed on said electrically insulating casing.

29. The integral battery of claim 28, wherein said electrical device includes at least one apparatus selected from the group consisting of a camera, a remote control unit, a charging circuit, a testing circuit, a current stabilizer, a personal communication device, and a battery indicator.
